(19) United States
(12) Patent Application Publication
(10) Pub. No.: US 2006/0210071 A1
(43) Pub. Date: Sep. 21, 2006

(54) Encryption of security-sensitive data

(76) Inventors: Gayathiri R. Chandran, San Jose, CA (US); James Willis Pickel, Gilroy, CA (US); Michael Ronald Springgay, Toronto (CA)

Correspondence Address: KONRAD RAYNES & VICTOR, LLP;ATTN: IBM54, 315 SOUTH BEVERLY DRIVE, SUITE 210, BEVERLY HILLS, CA, 90212, US

(21) Appl. No.: 11/082,474

(22) Filed: Mar. 16, 2005

(51) Int. Cl. H04L 9/00

(52) U.S. Cl. 380/42

(57) ABSTRACT

Techniques are provided for processing data. It is determined that a portion of a data stream to be transmitted includes a security-sensitive portion. The security-sensitive portion of the data stream is encrypted. The data stream with the encrypted security-sensitive portion is transmitted.

### BACKGROUND

1. Field

Embodiments of the invention relate to encryption of security-sensitive data.

2. Description of the Related Art

When a data stream contains a portion of security-sensitive data, the data stream may be encrypted before being transmitted from a first computer system to a second computer system. With currently available solutions, such as Secure Socket Layer (SSL), the entire data stream that is being transmitted is encrypted at the first computer system. Then, the second computer system decrypts the entire data stream. Thus, in conventional solutions, the entire data stream is encrypted, although only a portion of the data stream may contain security-sensitive information. In many situations, the entire data stream is much larger than the portion of the data stream that is security-sensitive. Therefore, performance is affected when the entire data stream is encrypted and decrypted. In light of this, there is a need in the art for improved encryption of a data stream.

### SUMMARY OF THE INVENTION

Provided are a method, article of manufacture, and system for processing data. It is determined that a portion of a data stream to be transmitted includes a security-sensitive portion. The security-sensitive portion of the data stream is encrypted. The data stream with the encrypted security-sensitive portion is transmitted.

### BRIEF DESCRIPTION OF THE DRAWINGS

Referring now to the drawings in which like reference numbers represent corresponding parts throughout:

FIG. 1 illustrates, in a block diagram, a computing environment in accordance with certain embodiments of the invention.

FIGS. 2A, 2B, and 2C illustrate data streams in accordance with certain embodiments.

FIG. 3 illustrates logic performed by the security-sensitive data system when transmitting a data stream in accordance with certain embodiments.

FIG. 4 illustrates logic performed by the security-sensitive data system when receiving a data stream in accordance with certain embodiments.

FIG. 5 illustrates logic performed by a client and server, respectively, in accordance with certain embodiments. FIG. 5 includes FIG. 5A, FIG. 5B, and FIG. 5C.

FIG. 6 illustrates, in a block diagram, a gateway computing environment in accordance with certain embodiments of the invention.

FIG. 7 illustrates logic performed by the security-sensitive data system when a data stream is received at a gateway computer in accordance with certain embodiments.

FIG. 8 illustrates logic performed by the security-sensitive data system when a data stream is received from a gateway computer at a destination computer in accordance with certain embodiments.

FIG. 9 illustrates an architecture of a computer system that may be used in accordance with certain embodiments.

### DETAILED DESCRIPTION

In the following description, reference is made to the accompanying drawings which form a part hereof and which illustrate several embodiments. It is understood that other embodiments may be utilized and structural and operational changes may be made without departing from the scope of the invention.

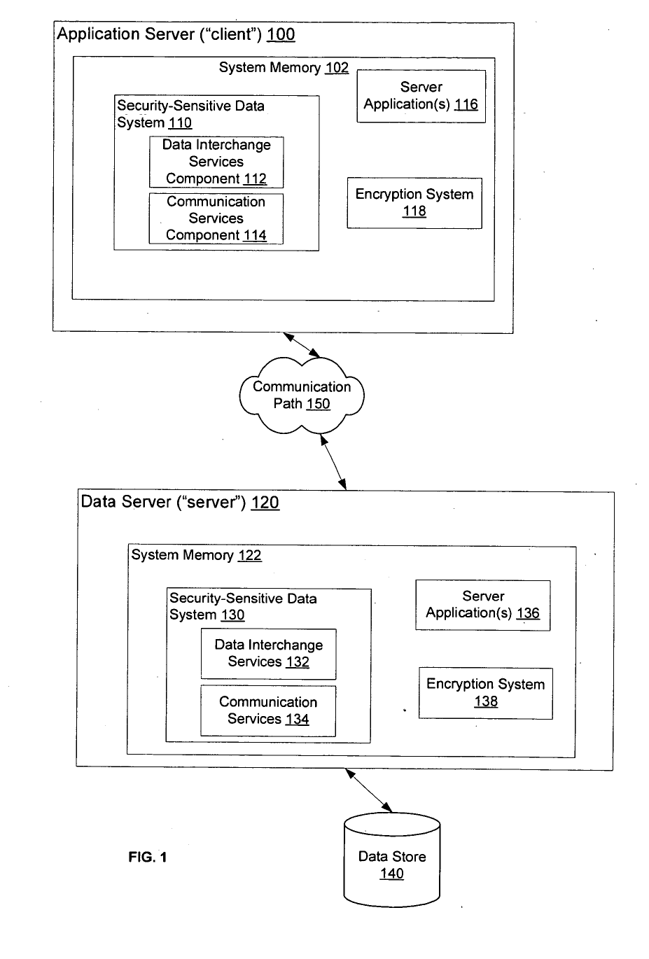

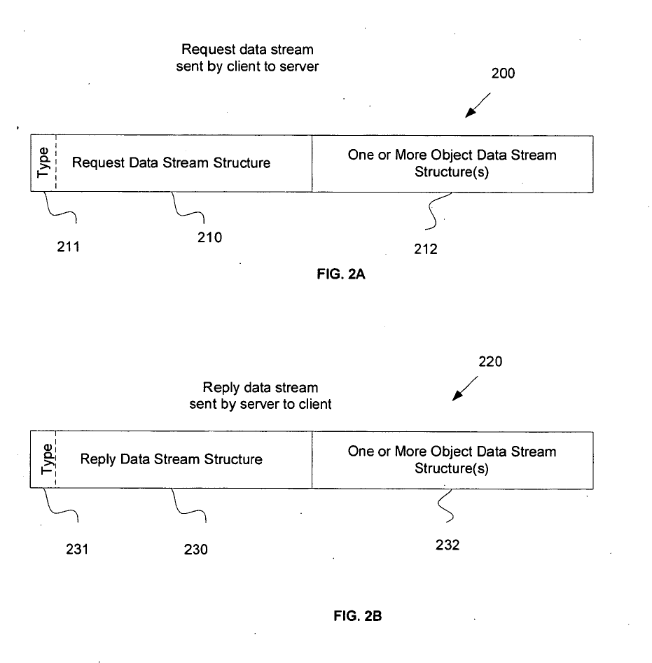

FIG. 1 illustrates, in a block diagram, a computing environment in accordance with certain embodiments of the invention. An application server 100 is connected via a communication path 150 to a data server 120. The application server 100 may also be referred to as a “client” because the application server 100 submits requests to the data server 120. The data server 120 may also be referred to as a “server” because the data server 120 responds to the requests with replies. The application server 100 includes system memory 102, which may be implemented in volatile and/or non-volatile devices. A security-sensitive data system 110, one or more server applications 116, and an encryption system 118 are stored in the system memory 102 for execution on application server 100. The security-sensitive data system 110 is capable of encrypting or decrypting security-sensitive data (e.g., security-sensitive user data) in a data stream. The security-sensitive data system 110 includes a data interchange services component 112 and a communication services component 114. The data interchange services component 112 identifies a security-sensitive portion of data. The communication services component 114 determines that a portion is identified as security-sensitive and calls the encryption system 118 to encrypt or decrypt the portion of security-sensitive data. When encryption is performed, the communication services component 114 marks the portion as being security sensitive and transmits the data stream. The marking enables the receiver of the data stream to identify the portion that has been encrypted.

The data server 120 includes system memory 122, which may be implemented in volatile and/or non-volatile devices. A security-sensitive data system 130, one or more server applications 136, and an encryption system 138 are stored in the system memory 122 for execution on data server 120. The security-sensitive data system 130 is capable of encrypting or decrypting security-sensitive data (e.g., security-sensitive user data) in a data stream. The security-sensitive data system 130 includes a data interchange services component 132 and a communication services component 134. The data interchange services component 132 identifies a security-sensitive portion of data. The communication services component 134 determines that a portion is identified as security-sensitive and calls the encryption system 138 to encrypt or decrypt the portion of security-sensitive data. When encryption is performed, the communication services component 134 marks the portion as being security sensitive and transmits the data stream. The marking enables the receiver of the data stream to identify the portion that has been encrypted.

The data server 120 provides the application server 100 with access to data in a data store 140.

The application server 100 and data server 120 may comprise any computing device known in the art, such as a server, mainframe, workstatation, personal computer, hand held computer, laptop telephony device, network appliance, etc. The communication path 150 may comprise any type of network, such as, for example, a Storage Area Network (SAN), a Local Area Network (LAN), Wide Area Network (WAN), the Internet, an Intranet, etc. The data store 140 may comprise an array of storage devices, such as Direct Access Storage Devices (DASDs), Just a Bunch of Disks (JBOD), Redundant Array of Independent Disks (RAID), virtualization device, etc.

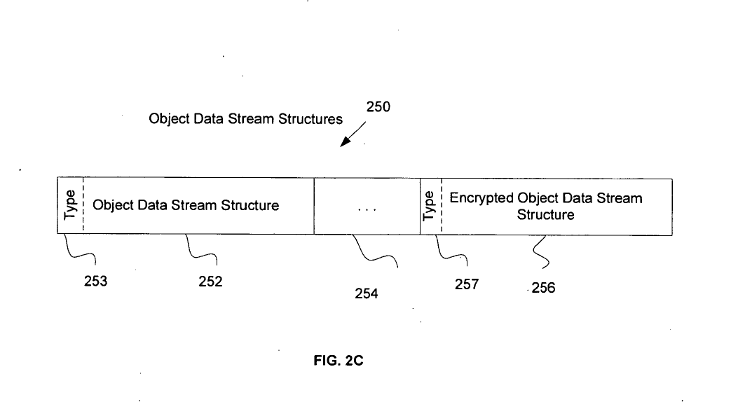

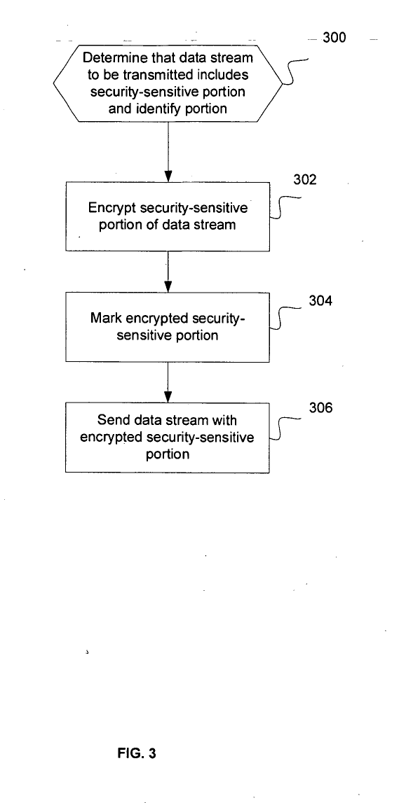

FIGS. 2A and 2B illustrate data streams 200, 220 in accordance with certain embodiments. Database data streams provide a well defined infrastructure in which data streams may include request data stream structures, reply data stream structures, object data stream structures, and encrypted object data stream structures. Each data stream structure includes a data stream structure header that identifies a data stream structure type as: request, reply, object or encrypted object.

In FIG. 2A, a request data stream 200 is one sent by a client to a server. The request data stream 200 includes a request data stream structure 210 and one or more object data stream structures 212. The request data stream structure has a data stream structure type 211 that indicates that it is a “request ”. A subset or all of the one or more object data stream structures 212 may be encrypted. Each unencrypted object has a data stream structure type that indicates that it is an “object”. Also, each encrypted object has a data stream structure type that indicates that it is an “encrypted object”.

In FIG. 2B, a reply data stream 220 is one sent by a server to a client. The reply data stream 220 includes a reply data stream structure 230 and one or more object data stream structures 232. The reply data stream structure has a data stream structure type 231 that indicates that it is a “reply”. A subset or all of the one or more object data stream structures 232 may be encrypted.

The request data stream structure 210 and reply data stream structure 230 contain database command data that is not security-sensitive. One or more of the object data stream structures 212, 232 may contain security-sensitive data.

FIG. 2C illustrates a sample set of object data stream structures 250. Object data stream structure 252 does not contain security-sensitive data and is not encrypted. Object data stream structure 256 contains security-sensitive data and is encrypted. The ellipses 254 indicate that there may be additional encrypted or unencrypted objects in the set 250. The object data stream structure has a data stream structure type 253 that indicates that it is an “object ”. Also, the encrypted object has a data stream structure type 257 that indicates that it is an “encrypted object”. Thus, the one or more object data stream structures 212, 232 that contain security-sensitive data are marked as containing such data (e.g., marked by setting a data stream structure type in a data stream structure header to encrypted object). Thus, the security-sensitive data system 110, 130 is able to determine that an object data stream structure that is so marked contains security-sensitive data.

FIG. 3 illustrates logic performed by the security-sensitive data system 110, 130 when transmitting a data stream in accordance with certain embodiments. Control begins at block 300 with the data interchange services component 112, 132 of the security-sensitive data system 110, 130 determining that a data stream to be transmitted includes a security-sensitive portion (i.e., some part of the data stream includes security-sensitive data) and identifying the portion. In block 302, the communication services component 114, 134 of the security-sensitive data system 110, 130 invokes the encryption system 118, 138 to encrypt the identified security-sensitive portion of the data stream. In block 304, the communication services component 114, 134 of the security-sensitive data system 110, 130 marks the encrypted portion. In block 306, the communication services component 114, 134 of the security-sensitive data system 110, 130 transmits the data stream with the encrypted security-sensitive portion. Thus, the entire data stream is not encrypted.

In certain embodiments, a database data stream is transmitted. The database data stream defines well formatted data structures that identify security-sensitive data, as are described in FIGS. 2A, 2B, and 2C. When transmitting a database data stream the portion encrypted may be marked by setting the data stream structure type to “encrypted object”. In other embodiments, the portion to be encrypted may be identified in another manner. For example, in another alternative, a client may send encrypted data in a first request object and non-encrypted data in a second request object, and the portion to be encrypted may be identified by the type of request object.

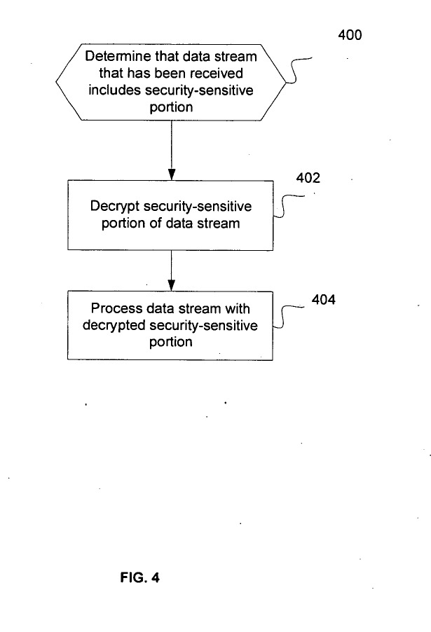

FIG. 4 illustrates logic performed by the security-sensitive data system 110, 130 when receiving a data stream in accordance with certain embodiments. Control begins at block 400 with communication services component 114, 134 of the security-sensitive data system 110, 130 determining that a data stream that has been received includes a security-sensitive portion (i.e., some part of the data stream includes security-sensitive data). In block 402, the communication services component 114, 134 of the security-sensitive data system 110, 130 invokes the encryption system 118, 138 to decrypt the security-sensitive portion of the data stream. In block 404, the security-sensitive data system 110, 130 processes the data stream with the decrypted security-sensitive portion. Thus, the entire data stream is not decrypted.

When receiving a database data stream, the portion to be decrypted may be identified based on a structure having a data stream structure type of “encrypted object”. In other embodiments, the portion to be decrypted may be determined in another manner (e.g., based on the type of request object where certain types include encrypted data).

By encrypting only the security-sensitive data, the cost of encryption and decryption is reduced, thus, improving performance. Encryption of only the security-sensitive data also provides good serviceability as command and diagnostic messages are not encrypted.

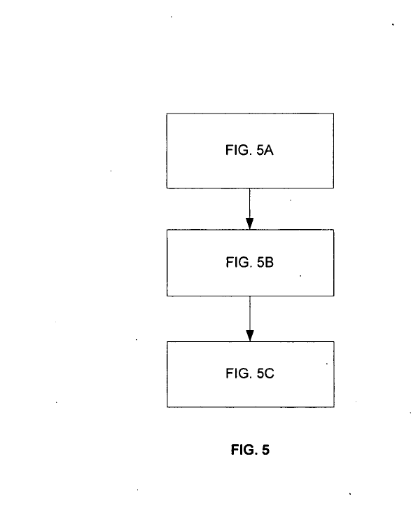

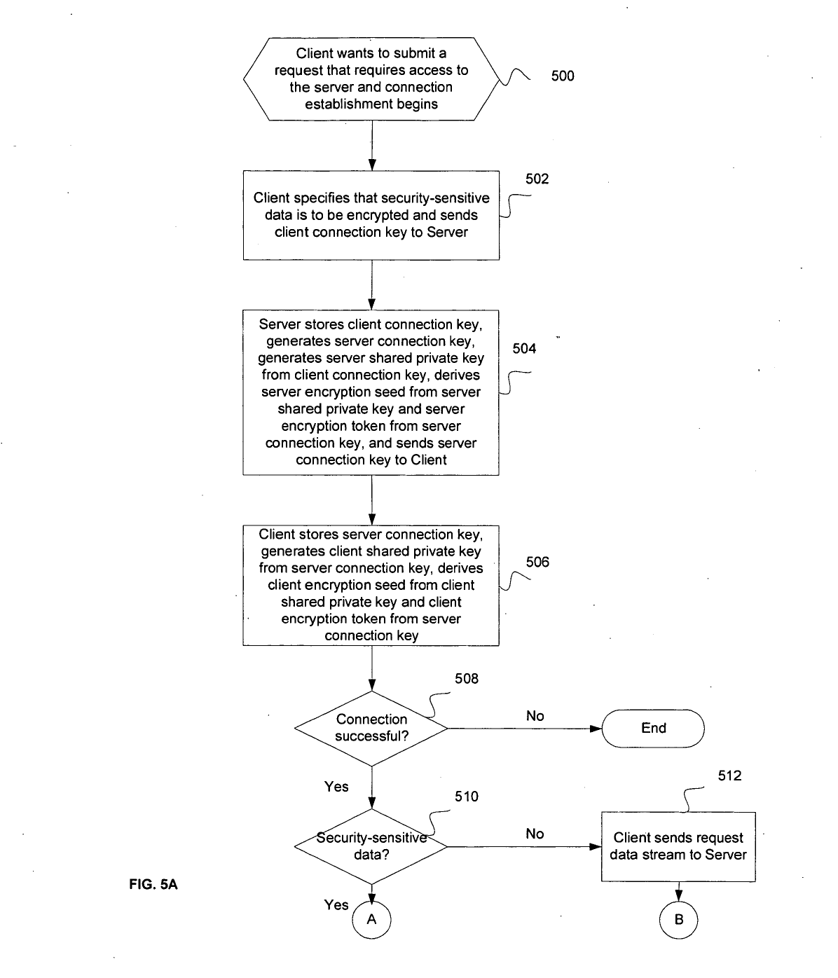

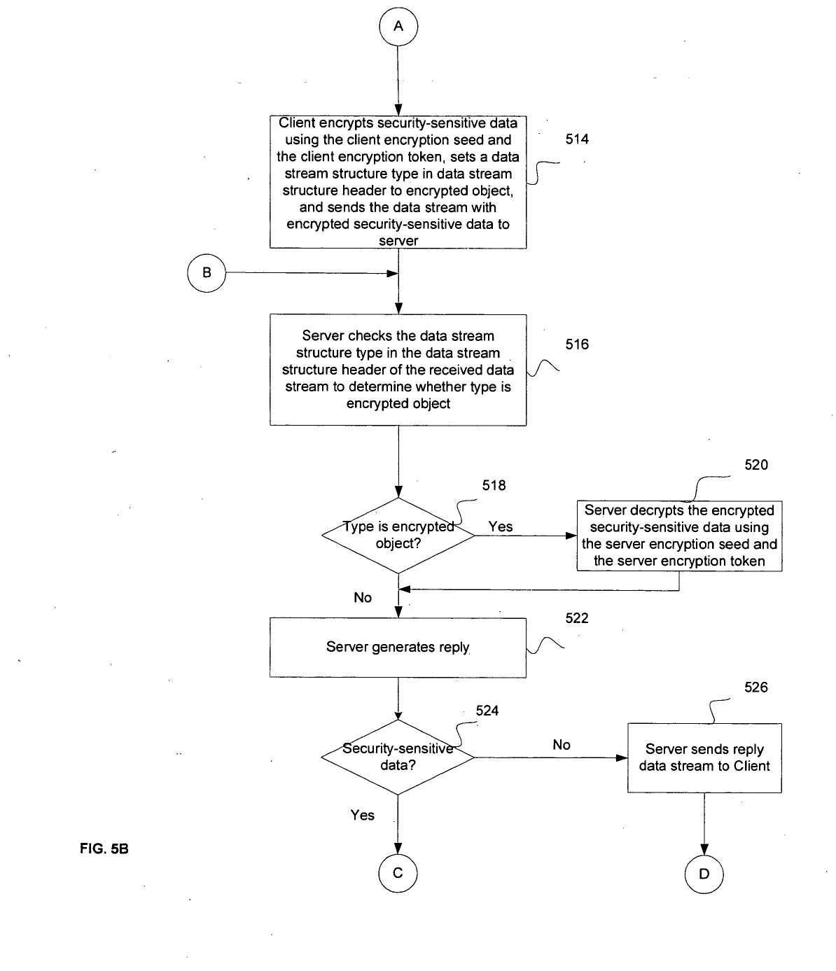

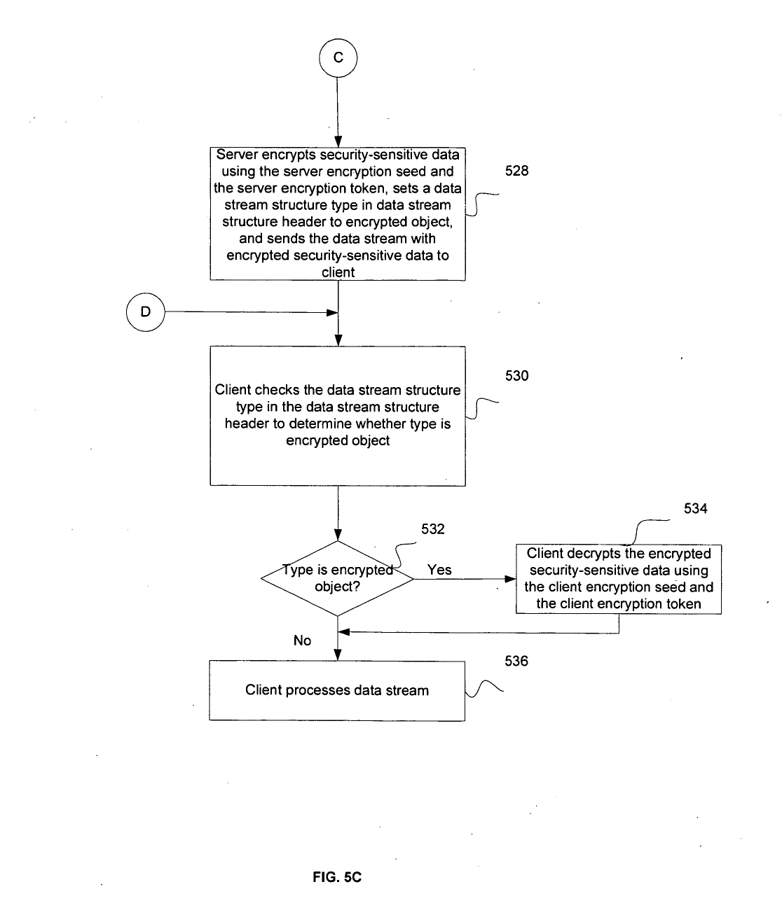

FIG. 5 illustrates logic performed by a client and server, respectively, in accordance with certain embodiments. FIG. 5 includes FIG. 5A, FIG. 5B, and FIG. 5C, where processing starts in FIG. 5A, continues from FIG. 5A to FIG. 5B, and continues from FIG. 5B to FIG. 5C.

Control begins at block 500 of FIG. 5A, with the client wanting to submit a request that requires access to the server and connection establishment begins. Connection establishment refers to creating a connection between the client and server so that data may be transmitted between them. During connection establishment, an encryption token and an encryption seed to be used for security-sensitive data encryption are generated by the client and server.

In block 502, the client specifies that security-sensitive data is to be encrypted (rather than all data) and sends a client connection key to the server. In particular, in block 504, the server stores the received client connection key, generates a server connection key, generates a server shared private key from the client connection key, derives a server encryption seed from the server shared private key and a server encryption token from the server connection key, and sends the server connection key to the client. In certain embodiments, the client and server connection keys and the client and server shared private keys are generated using a Diffie-Hellman distribution technique.

In block 506, the client stores the received server connection key, generates a client shared private key from the server connection key, and derives a client encryption seed from the client shared private key and a client encryption token from the server connection key. In block 508, the client determines whether the connection was successfully established. If so, processing continues to block 510, otherwise, processing ends.

In block 510, the client determines whether security-sensitive data (e.g., object data stream structures) is present in the request data stream. If so, processing continues to block 514 (FIG. 5B), otherwise, processing continues to block 512. In block 512, the client sends the request data stream to the server, and processing continues to block 516 (FIG. 5B).

In block 514, the client encrypts the security-sensitive data using the generated client encryption seed and the client encryption token, sets a data stream structure type in a data stream structure header to encrypted object, and sends the data stream with the encrypted security-sensitive data to the server.

In block 516, the server checks the data stream structure type in the data stream structure header of the received data stream to determine whether the type is encrypted object. In block 518, if the type is encrypted object, processing continues to block 520, otherwise, processing continues to block 522. In block 520, the server decrypts the encrypted security-sensitive data using the server encryption seed and the server encryption token, and processing continues to block 522.

In block 522, the server generates a reply. In block 524, the server determines whether security-sensitive data (e.g., object data stream structures) is present in the reply data stream. If so, processing continues to block 528 (FIG. 5C), otherwise, processing continues to block 526. In block 526, the server sends the reply data stream to the client, and processing continues to block 530 (FIG. 5B).

In block 528, the server encrypts security-sensitive data using the server encryption seed and the server encryption token, sets a data stream structure type in a data stream structure header to encrypted object, and sends the data stream with the encrypted security-sensitive data to the client.

In block 530, the client checks the data stream structure type in the data stream structure header to determine whether the type is encrypted object. In block 532, if the type is encrypted object, processing continues to block 534, otherwise, processing continues to block 536. In block 534, the client decrypts the encrypted security-sensitive data using the client encryption seed and the client encryption token, and processing continues to block 536. In block 536, the client processes the data stream.

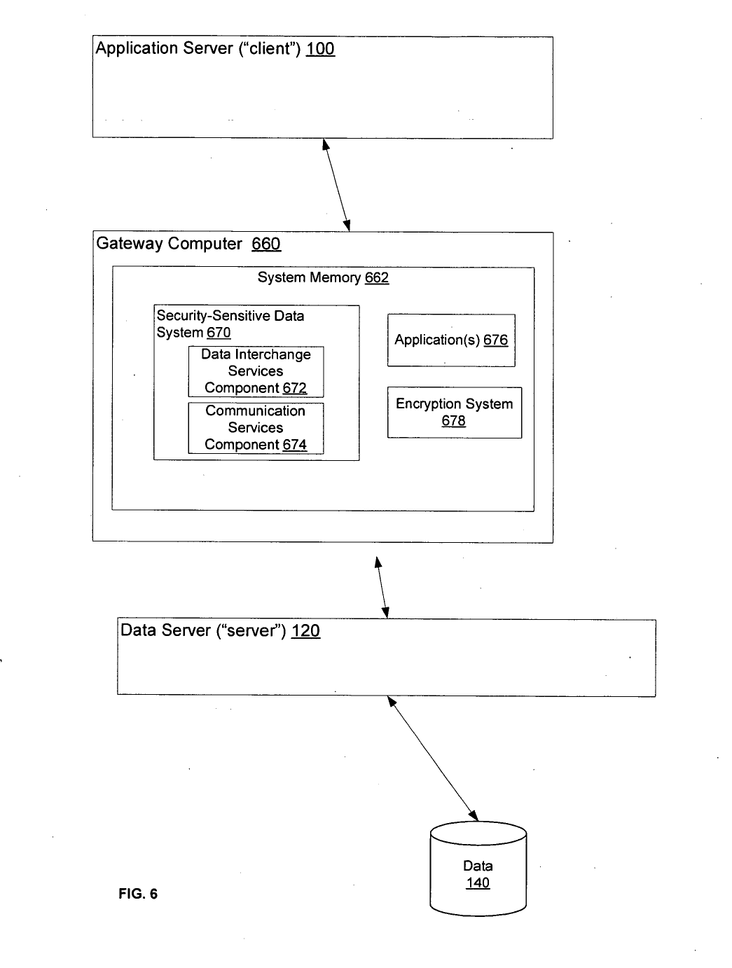

FIG. 6 illustrates, in a block diagram, a gateway computing environment in accordance with certain embodiments of the invention. In FIG. 6, a gateway computer 660 resides between application server 100 and data server 120. In particular, application server 100 is connected by a communication path to gateway computer 660, which, in turn, is connected by a communication path to data server 120. Details of the application server 100 and data server 120 are provided in FIG. 1. The gateway computer 660 includes system memory 662, which may be implemented in volatile and/or non-volatile devices. A security-sensitive data system 670, one or more applications 676, and an encryption system 678 are stored in the system memory 662 for execution on gateway computer 660. The security-sensitive data system 670 is capable of encrypting or decrypting security-sensitive data (e.g., security-sensitive user data) in a data stream. The security-sensitive data system 670 includes a data interchange services component 672 and a communication services component 674. The data interchange services component 672 identifies a security-sensitive portion of data. The communication services component 674 determines that a portion is identified as security-sensitive and calls the encryption system 678 to encrypt or decrypt the portion of security-sensitive data. When encryption is performed, the communication services component 674 marks the portion as being security sensitive (e.g., by setting an object data stream structure type as “encrypted object”) and transmits the data stream. The marking enables the receiver of the data stream to identify the portion that has been encrypted.

Although one gateway computer 660 is illustrated for simplicity and ease of understanding, any number of gateway computers may reside between the application server 100 and data server 120.

The application server 100, data server 120, and gateway computer 660 may comprise any computing device known in the art, such as a server, mainframe, workstatation, personal computer, hand held computer, laptop telephony device, network appliance, etc. Each computer system 100, 120, 660 may take on the role of “client”, “server”, or “gateway computer”.

Embodiments provide a gateway solution to avoid decrypting and re-encrypting the encrypted security-sensitive data stream. In the gateway solution, when the gateway computer 660 receives a data stream, the gateway acts as a “client”, and, when the gateway transmits a data stream, the gateway acts as a “server”.

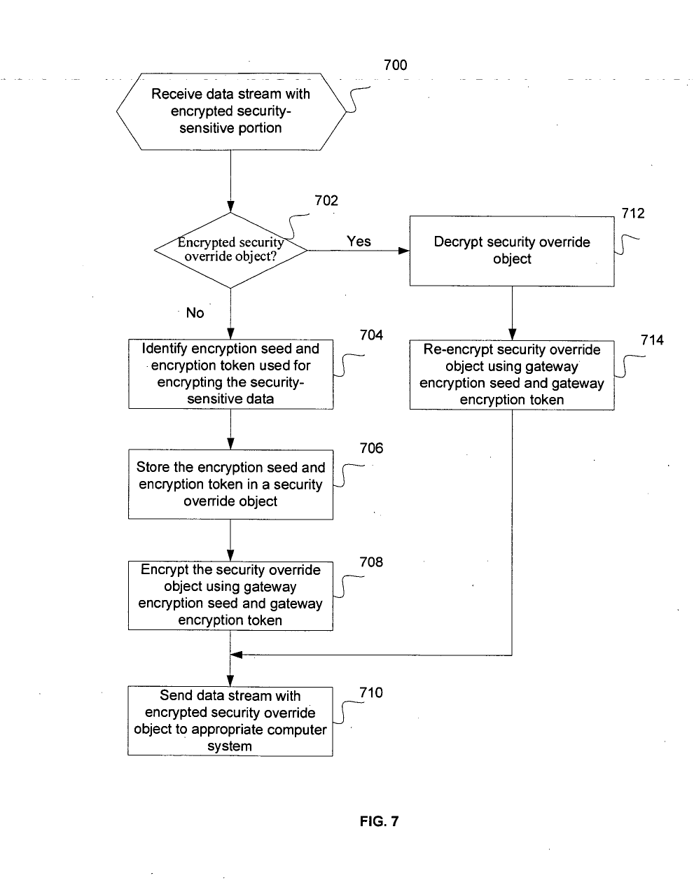

FIG. 7 illustrates logic performed by the security-sensitive data system 670 when a data stream is received at a gateway computer 660 in accordance with certain embodiments. Initially, connections are established between each pair of computer systems (e.g., a gateway computer and the application server 100, the same or another gateway computer 660 and the data server 120, any pair of gateway computers in the communication path between the application server 100 and the data server 120, etc.). During connection establishment, shared private keys, encryption tokens, and encryption seeds are generated at each computer system involved in the connection establishment.

Control begins at block 700 with the gateway computer 660 receiving a data stream with an encrypted security-sensitive portion. In block 702, the security-sensitive data system 670 determines whether the data stream includes an encrypted security override object. If so, processing continues to block 712, otherwise, processing continues to block 704.

In block 704, the security-sensitive data system 670 identifies the encryption seed and encryption token used for encrypting the security-sensitive data (i.e., the encryption seed and encryption token used by the sender of the data stream). In block 706, the security-sensitive data system 670 stores the encryption seed and encryption token in a security override object. In block 708, the security-sensitive data system 670 encrypts the security override object using a gateway encryption seed and a gateway encryption token. In block 710, the security-sensitive data system 670 transmits the data stream with the encrypted security override object to the appropriate computer system (e.g., application server 100, another gateway computer, or data server 120).

If the data stream includes an encrypted security override object, then the data stream is from another gateway computer. In block 712, the security-sensitive data system 670 decrypts the security override object. In block 714, the security-sensitive data system 670 re-encrypts the security override object using the gateway encryption seed and gateway encryption token, and processing continues to block 710.

Thus, if a gateway computer receives encrypted security-sensitive data (e.g., object data stream structures), then, instead of decrypting and re-encrypting the encrypted security-sensitive data, the gateway computer sends the encryption seed and the encryption token used for encrypting the security-sensitive data in a security override object and encrypts the security override object.

Also, if a gateway computer receives an encrypted security override object along with the encrypted security-sensitive data, then the gateway computer decrypts and re-encrypts the encrypted security override object, without having to decrypt and re-encrypt the security-sensitive data.

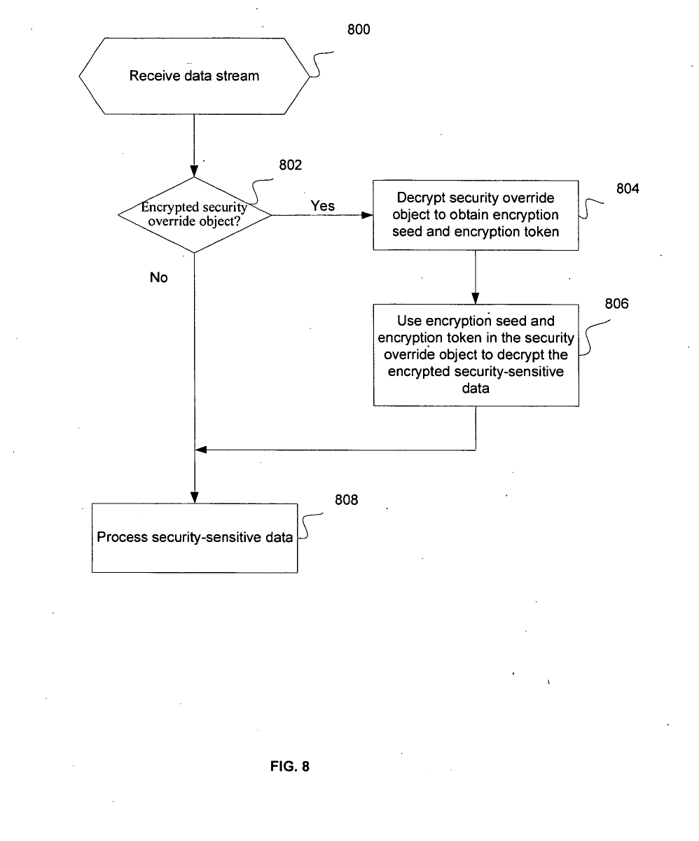

FIG. 8 illustrates logic performed by the security-sensitive data system 110, 130 when a data stream is received from a gateway computer 660 at a destination computer in accordance with certain embodiments. The term “destination” computer is used to refer to the computer system for which the data stream is destined (e.g., the application server 100 or the data server 120), rather than a gateway computer. Control begins at block 800, with the security-sensitive data system 110, 130 receiving a data stream. In block 802, the security-sensitive data system 110, 130 determines whether the data stream includes an encrypted security override object. If so, processing continues to block 804, otherwise, processing continues to block 808.

In block 804, the security-sensitive data system 110, 130 decrypts the security override object to obtain an encryption seed and an encryption token. In block 806, the security-sensitive data system 110, 130 uses the encryption seed and the encryption token in the security override object to decrypt the encrypted security-sensitive data, and processing continues to block 808. In block 808, the security-sensitive data system 110, 130 processes the security-sensitive data.

Thus, embodiments use a shared private key for encryption to secure security-sensitive data during transmission between computing systems by encrypting security-sensitive data in a data stream, rather than the entire data stream. Security-sensitive data stream encryption improves performance when processing online database transactions in client-server communications. For example, by identifying security-sensitive data and encrypting only the security-sensitive data in the data stream, performance is improved. Moreover, since error messages are not encrypted, it is easier to debug data stream problems, and, thus, encryption of security-sensitive data provides good serviceability.

Therefore, embodiments provide a fast and efficient technique to encrypt security-sensitive data in a distributed database transaction environment, such as a client server environment, using a shared private key.

### Additional Embodiment Details

The described embodiments may be implemented as a method, apparatus or article of manufacture using programming and/or engineering techniques to produce software, firmware, hardware, or any combination thereof. The term “article of manufacture” and “circuitry” as used herein refers to a state machine, code or logic implemented in hardware logic (e.g., an integrated circuit chip, Programmable Gate Array (PGA), Application Specific Integrated Circuit (ASIC), etc.) or a computer readable medium, such as magnetic storage medium (e.g., hard disk drives, floppy disks, tape, etc.), optical storage (CD-ROMs, optical disks, etc.), volatile and non-volatile memory devices (e.g., EEPROMs, ROMs, PROMs, RAMs, DRAMs, SRAMs, firmware, programmable logic, etc.). Code in the computer readable medium is accessed and executed by a processor. When the code or logic is executed by a processor, the circuitry may include the medium including the code or logic as well as the processor that executes the code loaded from the medium. The code in which preferred embodiments are implemented may further be accessible through a transmission media or from a file server over a network. In such cases, the article of manufacture in which the code is implemented may comprise a transmission media, such as a network transmission line, wireless transmission media, signals propagating through space, radio waves, infrared signals, etc. Thus, the “article of manufacture” may comprise the medium in which the code is embodied. Additionally, the “article of manufacture” may comprise a combination of hardware and software components in which the code is embodied, processed, and executed. Of course, those skilled in the art will recognize that many modifications may be made to this configuration, and that the article of manufacture may comprise any information bearing medium known in the art. Additionally, the devices, adapters, etc., may be implemented in one or more integrated circuits on the adapter or on the motherboard.

Certain embodiments may be directed to a method for deploying computing infrastructure by a person or automated processing integrating computer-readable code into a computing system, wherein the code in combination with the computing system is enabled to perform the operations of the described embodiments.

The term logic may include, by way of example, software or hardware and/or combinations of software and hardware.

The logic of FIGS. 3, 4, 5A, 5B, 5C, 7, and 8 describes specific operations occurring in a particular order. In alternative embodiments, certain of the logic operations may be performed in a different order, modified or removed. Moreover, operations may be added to the above described logic and still conform to the described embodiments. Further, operations described herein may occur sequentially or certain operations may be processed in parallel, or operations described as performed by a single process may be performed by distributed processes.

The illustrated logic of FIGS. 3, 4, 5A, 5B, 5C, 7, and 8 may be implemented in software, hardware, programmable and non-programmable gate array logic or in some combination of hardware, software, or gate array logic.

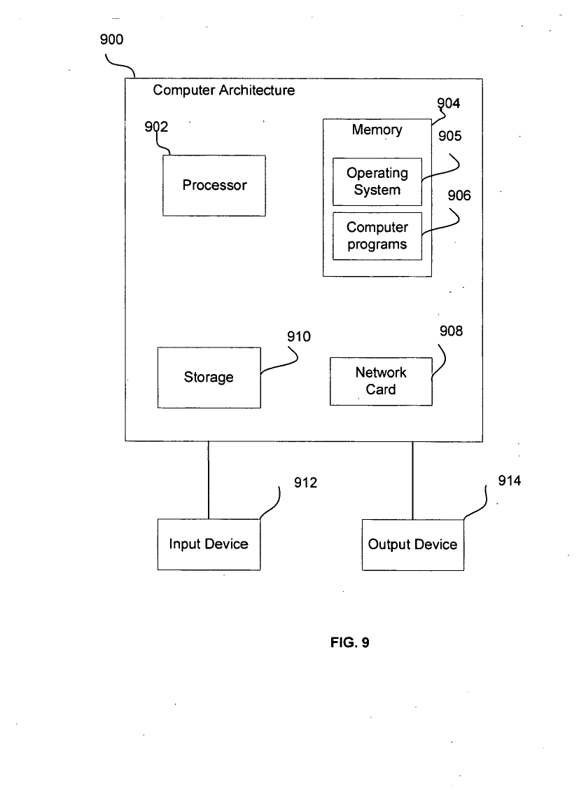

FIG. 9 illustrates an architecture 900 of a computer system that may be used in accordance with certain embodiments. Servers 100 and 120 and gateway computer 660 may implement architecture 900. The computer architecture 900 may implement a processor 902 (e.g., a microprocessor), a memory 904 (e.g., a volatile memory device), and storage 910 (e.g., a non-volatile storage area, such as magnetic disk drives, optical disk drives, a tape drive, etc.). An operating system 905 may execute in memory 904. The storage 910 may comprise an internal storage device or an attached or network accessible storage. Computer programs 906 in storage 910 may be loaded into the memory 904 and executed by the processor 902 in a manner known in the art. The architecture further includes a network card 908 to enable communication with a network. An input device 912 is used to provide user input to the processor 902, and may include a keyboard, mouse, pen-stylus, microphone, touch sensitive display screen, or any other activation or input mechanism known in the art. An output device 914 is capable of rendering information from the processor 902, or other component, such as a display monitor, printer, storage, etc. The computer architecture 900 of the computer systems may include fewer components than illustrated, additional components not illustrated herein, or some combination of the components illustrated and additional components.

The computer architecture 900 may comprise any computing device known in the art, such as a mainframe, server, personal computer, workstation, laptop, handheld computer, telephony device, network appliance, virtualization device, storage controller, etc. Any processor 902 and operating system 905 known in the art may be used.

The foregoing description of embodiments has been presented for the purposes of illustration and description. It is not intended to be exhaustive or to limit the embodiments to the precise form disclosed. Many modifications and variations are possible in light of the above teaching. It is intended that the scope of the embodiments be limited not by this detailed description, but rather by the claims appended hereto. The above specification, examples and data provide a complete description of the manufacture and use of the composition of the embodiments. Since many embodiments can be made without departing from the spirit and scope of the invention, the embodiments reside in the claims hereinafter appended or any subsequently-filed claims, and their equivalents.

What is claimed is:

1. A method for processing data, comprising:
determining that a portion of a data stream to be transmitted includes a security-sensitive portion;
encrypting the security-sensitive portion of the data stream;
marking the encrypted security-sensitive portion as encrypted; and
transmitting the data stream with the encrypted security-sensitive portion.

2. The method of claim 1, wherein the data stream comprises a first data stream, further comprising:
receiving a second data stream with an encrypted security-sensitive portion;
decrypting the security-sensitive portion of the second data stream; and
processing the second data stream.

3. The method of claim 1, wherein the data stream comprises a first data stream, further comprising:
receiving a second data stream with an encrypted security-sensitive portion;
identifying an encryption seed and an encryption token used for encrypting the security-sensitive portion;
storing the encryption seed and the encryption token in a security override object; and
transmitting the second data stream with the security override object.

4. The method of claim I, wherein the data stream comprises a first data stream, further comprising:
receiving a second data stream with a security override object;
decrypting the security override object;
re-encrypting the security override object; and
transmitting the second data stream with the re-encrypted security override object.

5. The method of claim 1, wherein the data stream comprises a first data stream, further comprising:
receiving a second data stream with a security override object;
decrypting the security override object to obtain the encryption seed and the encryption token; and
using the encryption seed and the encryption token to decrypt the encrypted security-sensitive data.

6. The method of claim 1, wherein the data stream comprises a database data stream and wherein the security-sensitive portion comprises an object data stream structure.

7. The method of claim 1, further comprising:
setting a data stream structure type in a data stream structure header to encrypted object.

8. The method of claim 1, further comprising:
establishing a connection with another computer system with an indication that a security-sensitive portion of each data stream is to be encrypted without encrypting the entire data stream.

9. An article of manufacture including a program for processing data, wherein the program is capable of causing operations to be performed, the operations comprising:
determining that a portion of a data stream to be transmitted includes a security-sensitive portion;
encrypting the security-sensitive portion of the data stream;
marking the encrypted security-sensitive portion as encrypted; and
transmitting the data stream with the encrypted security-sensitive portion.

10. The article of manufacture of claim 9, wherein the data stream comprises a first data stream, and wherein the operations further comprise:
receiving a second data stream with an encrypted security-sensitive portion;
decrypting the security-sensitive portion of the second data stream; and
processing the second data stream.

11. The article of manufacture of claim 9, wherein the data stream comprises a first data stream, and wherein the operations further comprise:
receiving a second data stream with an encrypted security-sensitive portion;
identifying an encryption seed and an encryption token used for encrypting the security-sensitive portion;
storing the encryption seed and the encryption token in a security override object; and
transmitting the second data stream with the security override object.

12. The article of manufacture of claim 9, wherein the data stream comprises a first data stream, and wherein the operations further comprise:
receiving a second data stream with a security override object;
decrypting the security override object;
re-encrypting the security override object; and
transmitting the second data stream with the re-encrypted security override object.

13. The article of manufacture of claim 9, wherein the data stream comprises a first data stream, and wherein the operations further comprise:
receiving a second data stream with a security override object;
decrypting the security override object to obtain the encryption seed and the encryption token; and
using the encryption seed and the encryption token to decrypt the encrypted security-sensitive data.

14. The article of manufacture of claim 9, wherein the data stream comprises a database data stream and wherein the security-sensitive portion comprises an object data stream structure.

15. The article of manufacture of claim 9, and wherein the operations further comprise:
setting a data stream structure type in a data stream structure header to encrypted object.

16. The article of manufacture of claim 9, and wherein the operations further comprise:
establishing a connection with another computer system with an indication that a security-sensitive portion of each data stream is to be encrypted without encrypting the entire data stream.

17. A system for processing data, comprising:
circuitry capable of causing operations to be performed, the operations comprising:
determining that a portion of a data stream to be transmitted includes a security-sensitive portion;
encrypting the security-sensitive portion of the data stream;
marking the encrypted security-sensitive portion as encrypted; and
transmitting the data stream with the encrypted security-sensitive portion.

18. The system of claim 17, wherein the data stream comprises a first data stream, and wherein the operations further comprise:
receiving a second data stream with an encrypted security-sensitive portion;
decrypting the security-sensitive portion of the second data stream; and
processing the second data stream.

19. The system of claim 17, wherein the data stream comprises a first data stream, and wherein the operations further comprise:
receiving a second data stream with an encrypted security-sensitive portion;
identifying an encryption seed and an encryption token used for encrypting the security-sensitive portion;
storing the encryption seed and the encryption token in a security override object; and
transmitting the second data stream with the security override object.

20. The system of claim 17, wherein the data stream comprises a first data stream, and wherein the operations further comprise:
receiving a second data stream with a security override object;
decrypting the security override object;
re-encrypting the security override object; and
transmitting the second data stream with the re-encrypted security override object.

21. The system of claim 17, wherein the data stream comprises a first data stream, and wherein the operations further comprise:
receiving a second data stream with a security override object;
decrypting the security override object to obtain the encryption seed and the encryption token; and
using the encryption seed and the encryption token to decrypt the encrypted security-sensitive data.

22. The system of claim 17, wherein the data stream comprises a database data stream and wherein the security-sensitive portion comprises an object data stream structure.

23. The system of claim 17, and wherein the operations further comprise:
setting a data stream structure type in a data stream structure header to encrypted object.

24. The system of claim 17, and wherein the operations further comprise:
establishing a connection with another computer system with an indication that a security-sensitive portion of each data stream is to be encrypted without encrypting the entire data stream.
